(19) United States
(12) Patent Application Publication
(10) Pub. No.: US 2026/0268566 A1
(43) Pub. Date: Sep. 10, 2026

(54) ANIMATED REMOTE APPAREL FITTING

(71) Applicant: SpreeAI Corporation, Incline Village, NV (US)

(72) Inventors: Minh Phuoc Vo, Alameda, CA (US); Aayush Bansal, Pittsburgh, PA (US); Junkun Chen, Urbana, IL (US)

(73) Assignee: SpreeAI Corporation, Incline Village, NV (US)

(21) Appl. No.: 19/075,534

(22) Filed: Mar. 10, 2025

(51) Int. Cl. G06T 13/40; G06T 5/60; G06T 7/11; G06T 7/73; G06T 19/00

(52) U.S. Cl. CPC G06T 13/40; G06T 5/60; G06T 7/11; G06T 7/73; G06T 19/00; G06T 19/20; G06T 2200/24; G06T 2207/10016; G06T 2207/20081; G06T 2207/20084; G06T 2207/30196; G06T 2210/16

(57) ABSTRACT

In accordance with the described techniques, a processing device receives a first image of a subject person, a second image of a clothing item, and a first video depicting a person moving with reference movements. A first machine-learning model that generates conditioning sequences based on the first image, the second image, and the first video. A second machine-learning model that uses the conditioning sequences to generate a second video of the clothing item virtually fitted on the subject person moving with the reference movements. The processing device then presents the second video via a display. The techniques enable virtual try-on of clothing items with realistic movement and fit visualization.

### BACKGROUND

Online shopping for clothing has become increasingly prevalent, offering convenience and a wide selection. However, this trend has introduced challenges for consumers in determining how garments will fit and appear. Unlike in-store shopping where individuals can try on items, online shoppers often struggle to gauge whether a particular piece of clothing will suit their body type or match their style preferences. This uncertainty leads to dissatisfaction with purchases, increased returns, and hesitation in buying clothing online. Additionally, the variation in sizing across different brands and even within the same brand compounds this issue, making it difficult for consumers to select items that will fit confidently.

### SUMMARY

Techniques and systems for generating virtual try-on videos with motion are described. In one example, a processing device receives an input image of a subject person, an image of a clothing item, and a reference video showing a series of movements. The input image depicts the subject person, preferably from a front-or side-facing perspective. For example, a person browsing an online clothing catalog wants to see how different garments would look on them while moving (e.g., turning around). A first machine-learning model, such as one or more conditioning networks, uses these inputs to generate one or more conditioning sequences.

A second machine-learning model, such as a diffusion transformer with multiple transformer layers, uses the conditioning sequences to generate a video of the subject person virtually wearing the clothing item and performing the movements from the reference video. The processing device displays the generated video, allowing users to visualize themselves wearing the selected garment in motion (e.g., from multiple angles or perspectives). This approach enables a more immersive and informative virtual try-on experience compared to static images, helping consumers make more confident purchasing decisions for clothing items.

The system can further refine the generated video using an auto-regressive video refiner, enhancing visual quality and consistency. Additionally, the system supports user customization through text prompts, allowing minor edits to the movements or clothing items in the generated video. The diffusion transformer employs specialized training techniques to optimize its performance in generating realistic portrayals, including a multi-phase approach that gradually increases the complexity of the garment-to-body associations during training.

By combining advanced machine learning techniques with intuitive user inputs, the described techniques provide a versatile and user-friendly virtual try-on experience that goes beyond traditional static image-based approaches. Users can see how garments fit and how they move and drape during various activities, offering a more comprehensive understanding of the clothing item before purchase.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described regarding the accompanying figures. Entities represented in the figures indicate one or more entities; thus, reference is made interchangeably to single or plural forms of the entities in the discussion.

FIG. 1 illustrates a digital medium environment n an example implementation that is operable to employ animated remote apparel fitting techniques as described herein.

FIG. 2 depicts a system in an example implementation that shows the operation of a garment fit service of FIG. 1 in greater detail employing the techniques for animated remote apparel fitting described herein.

FIG. 3 illustrates a block diagram of conditioning networks and a diffusion transformer of FIG. 2 for generating virtual try-on videos.

FIG. 4 illustrates a block diagram of a system or processing and refining video frames through multiple stages to generate a higher-quality refined video.

FIG. 5 depicts a system and procedure in an example implementation for training a machine-learning model as part of a machine-learning system.

FIG. 6 illustrates a series of training phases for a garment try-on system.

FIGS. 7A-7C illustrate virtual try-on demonstration sequences generated by the described garment fit service and a conventional model.

FIG. 8 illustrates a flowchart of a method for an implementation of animated remote apparel fitting techniques as described herein.

FIG. 9 illustrates an example system, which includes an example computer that represents one or more computing systems and/or devices usable to implement the techniques described herein.

### DETAILED DESCRIPTION

### Overview

Online shopping for clothing has become increasingly popular, offering convenience and a wide selection. However, this trend has introduced significant challenges for consumers in determining how garments will fit and appear. Unlike in-store shopping where individuals can try on items, online shoppers often struggle to gauge whether a particular piece of clothing will suit their body type or match their style preferences. This uncertainty often leads to dissatisfaction with purchases, increased returns, and hesitation in buying clothing online.

To address these challenges, retailers and manufacturers often provide sizing charts that display a garment's measurements in different sizes. These charts typically include key measurements like chest, waist, hips, and sleeve length, indicating which size corresponds to each range of body measurements. While intended to assist consumers in choosing well-fitting clothes, sizing charts are challenging to navigate due to variations across brands and body types. Sizing charts generally focus on key measurements and do not account for other factors like body shape, height, clothing design, and personal preferences.

Similarly, retailers and manufacturers frequently offer preview images of their clothing items, showing how they fit on models or mannequins. These preview images try to capture fine-grain garment fitness, such as looseness on the shoulders or tightness at the waist. However, many online experiences still make it challenging to accurately assess the fit and style match because of differences in body types between online shoppers and the models in preview images. Even when composite or comparison images are available with coarse style editing (e.g., tucking in shirts), it remains difficult for shoppers to determine the precise fit of different clothing items for their particular body type and preferences.

The described techniques for animated remote apparel fitting address these limitations by providing a more immersive and informative virtual try-on experience. By combining advanced machine-learning models with user inputs, the described techniques generate dynamic video representations of clothing items (e.g., tops, bottoms, dresses, etc.) on a digital representation of the shopper. Users can see how garments fit and how they move and drape during various activities, offering a more comprehensive understanding of the clothing item before purchase.

In one example, a remote fitting service uses machine-learning models, including conditioning networks and a diffusion transformer, to process inputs. The inputs include an image of the shopper, an image of the clothing item, and a reference video showing a series of reference movements. The reference video, for example, is selectable from preloaded videos showing different try-on movements (e.g., a shopper slowly turning around and moving different body parts to show the fit of a clothing item). The remote fitting service then generates a video of the shopper virtually wearing the selected garment and performing the reference movements. The video allows online shoppers to visualize themselves wearing the item in motion, providing a more realistic and informative representation than static images alone. Additionally, the system supports user customization through text prompts, enabling minor edits to the reference movements or clothing items in the generated video.

By offering dynamic and customizable virtual try-on experiences, the remote fitting service improves consumer confidence in online clothing purchases, potentially reducing returns and improving overall satisfaction with the online shopping experience. In this way, the described remote fitting service enables both garment try-on and temporally consistent motion generation, including single-image try-on and video-to-video try-on with optional reposing. The described techniques can handle arbitrary garments and is robust to various garment capture techniques, allowing in some scenarios for users to point to a garment worn by another person and perform try-on. In addition, the described remote fitting service compositely learns multiple modalities, enabling minor garment edits through text prompts.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Animated Remote Fitting Environment

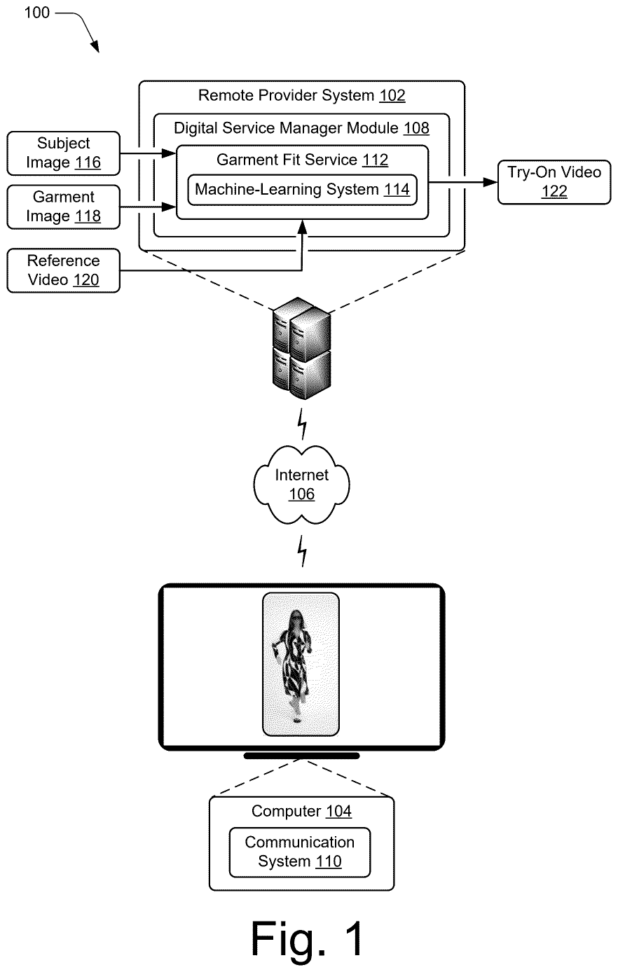

FIG. 1 illustrates a digital medium environment 100 in an example implementation that is operable to employ animated remote apparel fitting techniques as described herein. The illustrated digital medium environment 100 includes a remote provider system 102 and a computer 104 that are communicatively coupled, one to another, via the internet 106 or another wired or wireless network. Computing systems for the remote provider system 102 and the computer 104 are configurable in various ways. For instance, computer 104 is associated with a user, and remote provider system 102 is a remote computing system (e.g., one or more servers) configured to employ the described techniques and systems for animated remote apparel fitting.

A computing system, for instance, is configurable as a desktop computer, laptop computer, mobile device (e.g., assuming a handheld configuration such as a tablet or mobile phone), server, and so forth. Thus, the remote provider system 102 or the computer 104 can range from a full-resource device with substantial memory and processor resources (e.g., servers and personal computers) to a low-resource device with limited memory and/or processing resources (e.g., some mobile devices). Additionally, although a single computing device is shown for the computer 104 and described in instances in the following discussion, a computing system is also representative of a plurality of different devices, such as multiple servers utilized by a business to perform operations “over the cloud” for the remote provider system 102.

The remote provider system 102 includes a digital service manager module 108 implemented using hardware and software resources (e.g., a processing device and computer-readable storage medium) to support one or more digital services (e.g., an online clothing marketplace). The digital services are made available remotely via the Internet 106 to computing devices (e.g., computer 104).

The digital services are scalable through implementation by the hardware and software resources and support a variety of functionalities, including accessibility, verification, real-time processing, analytics, load balancing, and so forth. Examples of digital services include a social media service, online marketplace, streaming service, digital content repository service, content collaboration service, and so on. Accordingly, in the illustrated example, a communication system 110 (e.g., browser, network-enabled application, and so on) is utilized by the computer 104 to access digital services via the Internet 106. The result of processing using the digital services is then returned to the computer 104 via the Internet 106.

In the illustrated digital medium environment 100, the digital services include a garment fit service 112 for assisting online purchasers in finding clothes and sizes that fit well to make more informed purchasing decisions. For example, the garment fit service 112 uses a machine-learning system 114 to process a subject image 116, a garment image 118, and a reference video 120 to generate a try-on video 122. The subject image 116 capturing an image of the purchaser (or another consumer), preferably from a front or side perspective. The garment image 118 provides an example image of the clothing item to be virtually tried on. The reference video 120 shows a series of reference movements that will be applied to the virtual try-on.

The garment fit service 112 generates a digital representation of the purchaser from the subject image 116. The garment fit service 112 also captures the fine-grain garment fit and style from the garment image 118 and transfers those details to the try-on video 122, while also incorporating the reference movements from the reference video 120. In one implementation, the garment fit service 112 readily depicts the purchaser with alternate sizes or clothing items, upon the user's interaction with a user interface (UI) of the computer 104. Visually, the garment fit service 112 creates realistic animations of the user wearing different clothing items, indicating their fit and how the clothing items look and drape on the user in motion.

As previously described, conventional online marketplaces generally just provide static images (of models or mannequins wearing the clothing items) or sizing charts to assist users in selecting an appropriate size and/or determining if the clothing item will fit the user as desired. Some conventional techniques utilize diffusion models to create videos from text and/or images. Generating videos from text generally requires detailed descriptions in the text prompt or the diffusion model struggles to capture relevant details. In addition, error propagation and occlusion artifacts that arise when transitioning from a single generated image to video frames limit the ability to extend single-image try-on in a modular manner. Another challenge faced by conventional techniques is how to guide a machine-learning model to generate the desired motion. One approach to address this challenge is to use text-guided motion. While simple motions like a turn-around, are describable via text, the complexity increases as the nuances in the motion become more subtle.

To address this, the described remote apparel fitting techniques, allow users to select (e.g., from preset example videos) or upload the reference video 120 to generate the desired motion and also to make minor edits via a text prompt. To do so, the garment fit service 112 is configurable to employ the machine-learning system 114 to determine a user's measurements and characteristics from a single uploaded image (e.g., the subject image 116). The user's measurements are used to generate a digital representation of the user wearing the selected clothing item. This machine-learning system 114 also uses garment image 118 and reference video 120 to generate the try-on video 122 that displays the selected clothing item on the digital representation of the user in motion. The try-on video 122 provides a dynamic visualization of the user (based on the subject image 116) wearing the selected clothing item and performing the reference movements from reference video 120. The try-on video 122 also indicates the fit and visual appearance of the clothing item on the digital representation of the user during various movements. Further discussion of these and other examples is included in the following section and shown in the corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Animated Digital Fitting System

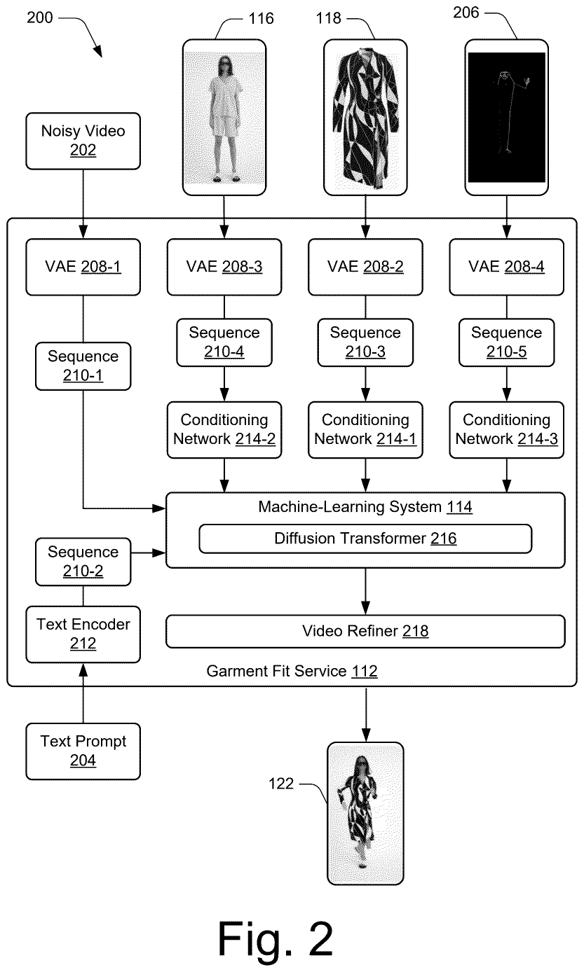

FIG. 2 depicts a system 200 in an example implementation that shows the operation of the garment fit service 112 of FIG. 1 in greater detail employing the techniques for animated remote apparel fitting described herein.

In system 200, the garment fit service 112 receives multiple inputs including a noisy video 202, a text prompt 204, a subject image 116, a garment image 118, and a skeleton video 206.

The noisy video 202 serves as an initial input for the diffusion process during video generation. The noisy video 202 may include random noise, Gaussian noise, or low-quality video content that provides a starting point for the video generation process. In some implementations, the noisy video 202 has the same dimensions and frame count as the desired output video, allowing the system to gradually refine and transform it into the final try-on video 122. The use of a noisy video input can help the machine-learning system 114 generate more diverse and realistic outputs by providing a source of randomness and variability in the video generation process.

The text prompt 204 is a user-provided input that includes additional instructions or modifications for the virtual try-on process. For example, the text prompt 204 includes natural language descriptions of desired garment alterations, specific pose requests, or style preferences to guide the video generation. In some implementations, the user does not provide the text prompt 204.

The skeleton video 206 includes a sequence of frames representing the skeletal structure or key body points of a person performing a series of reference movements (e.g., the reference movements of the reference video 120). This skeletal representation serves as a guide for mapping the reference movements onto the digital representation of the user in the try-on video 122. In some implementations, the skeleton video 206 is derived from the reference video 120 or generated separately using pose estimation techniques.

The garment fit service 112 includes multiple variational autoencoders 208 that process the inputs to compress and extract relevant information as sequences 210. A VAE 208 is a type of neural network architecture that learns to encode input data into a compressed latent representation and then decode it back to reconstruct the original input. VAEs 208 may be used to process and encode different types of input data, such as images and videos, into compact latent representations that capture important features and characteristics of the input (e.g., sequences 210). These encoded representations, referred to as sequences 210 herein, allow for efficient processing and manipulation of complex visual information. By employing VAEs, the garment fit service 112 compresses and extracts relevant information from the subject image 116, garment image 118, noisy video 202, and skeleton video 206, enabling the system 200 to generate realistic and personalized virtual try-on videos.

The sequences 210 output by the VAEs 208 are compact, encoded representations of input data (e.g., the subject image 116, garment image 118, noisy video 202, and skeleton video 206) that capture key features and characteristics in a latent space. These sequences 210 include information about body shape, garment style, or motion patterns, depending on the input processed by the VAE 208. By representing complex visual information in a condensed format, the sequences 210 enable efficient processing and manipulation of data by the garment fit service 112.

A first VAE 208-1 processes the noisy video 202 and encodes this noisy input into a first sequence 210-1, which forms the starting point for the video generation process by the machine-learning system 114. A second VAE 208-2 processes the garment image 118 to generate a third sequence 210-3, which encodes important features of the clothing item such as its style, measurements, texture, and shape in the latent space. A third VAE 208-3 processes the subject image 116 to generate a fourth sequence 210-4 that encodes key features of the subject's appearance and body shape. A fourth VAE 208-4 processes the skeleton video 206 to generate a fifth sequence 210-5 that encodes the temporal dynamics of the reference movements.

The text prompt 204 undergoes processing through a text encoder 212, which converts the textual information into a format compatible with the other input sequences, allowing it to influence generation of the try-on video 122. The text encoder 212 is a neural network designed to process and convert textual input (e.g., text prompt 204) into a numerical representation compatible with the other input sequences 210 used in the video generation process. In operation, the text encoder 212 receive the text prompt 204 as input and transform it into a sequence of vectors or embeddings that capture the semantic meaning and style information contained in the text prompt 204 as a second sequence 210-2. The second sequence 210-2 is used with the other input sequences 210, allowing the textual information to guide and influence the generation of the try-on video 122. In one implementation, the text encoder 212 employs techniques such as transformer architectures or recurrent neural networks to capture the context and nuances of the textual input. By incorporating the text encoder 212, the garment fit service 112 enables users to provide more detailed and specific instructions for customizing the virtual try-on experience, enhancing the flexibility and user-friendliness of the described system and techniques.

The sequences 210-3, 210-4, and 210-5 are processed by corresponding conditioning networks 214. Conditioning networks 214 are specialized neural networks that process and refine encoded information (e.g., sequences 210) to prepare the information for use in subsequent stages of the video generation process. The garment fit service 112 uses the conditioning networks 214 to process the sequences 210 output by the VAEs 208 to extract and emphasize relevant features for virtual try-on video generation. In one or more implementations, the conditioning networks 214 use techniques such as attention mechanisms, residual connections, or transformer architectures to combine and transform the input sequences 210. By processing the sequences 210 corresponding to the subject person, garment, and reference movement separately, the conditioning networks 214 allow the machine-learning system 114 to maintain and refine distinct aspects of each input modality. The separate processing also enables the machine-learning system 114 to more effectively combine these refined representations when generating the try-on video 122, improving the quality and accuracy of the virtual garment fitting and movement synthesis. The conditioning networks 214 use cross-attention to integrate multi-modal inputs (e.g., the input images, text prompt, and video), improve garment registration by the machine-learning system 114, and support diverse garment types (e.g., tops, bottoms, dresses, etc.). In system 200, a first conditioning network 214-1 processes the third sequence 210-3 from the second VAE 208-2, a second conditioning network 214-2 processes the fourth sequence 210-4 from the third VAE 208-3, and a third conditioning network 214-3 processes the fifth sequence 210-5 from the fourth VAE 208-4.

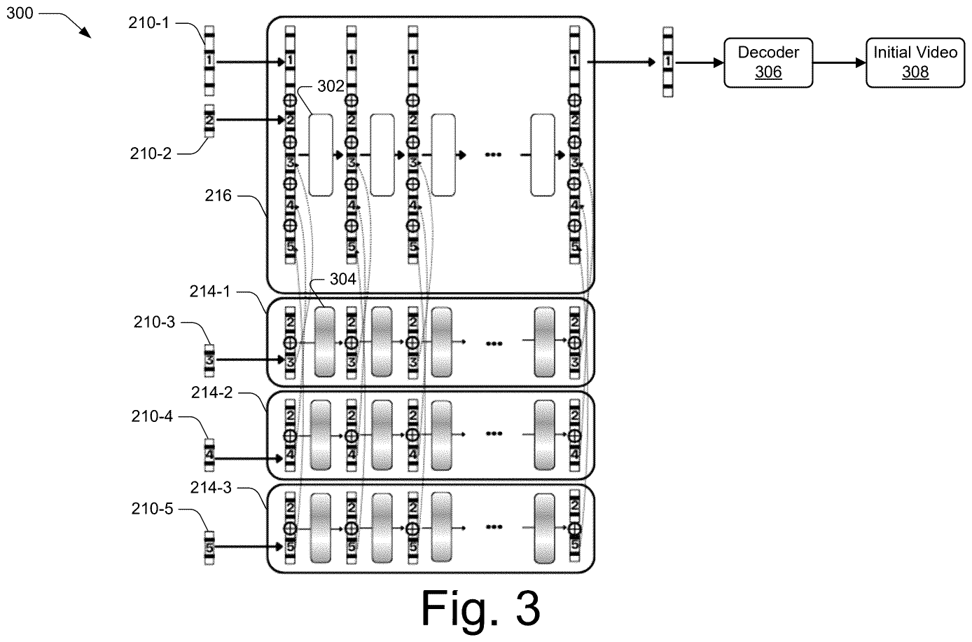

The machine-learning system 114 uses a diffusion transformer 216 that receives and processes the sequences 210. The diffusion transformer 216 is a specialized neural network architecture designed to generate high-quality video content from input sequences. These specialized neural networks combine the principles of diffusion models with transformer-based architectures to process and synthesize complex visual information. In operation, the diffusion transformer 216 takes the encoded sequences 210, gradually refining and transforming the encoded information through multiple layers to generate the try-on video 122. The diffusion process allows the model to iteratively denoise and improve the video quality, while the transformer architecture enables effective processing of long-range dependencies in both spatial and temporal dimensions. By leveraging attention mechanisms and self-supervised learning techniques, the diffusion transformer 216 generates realistic and temporally consistent videos that accurately represent the subject wearing the selected garment(s) in motion. The operation of the diffusion transformer 216 and its use of the sequences 210 is described in greater detail with respect to FIG. 3.

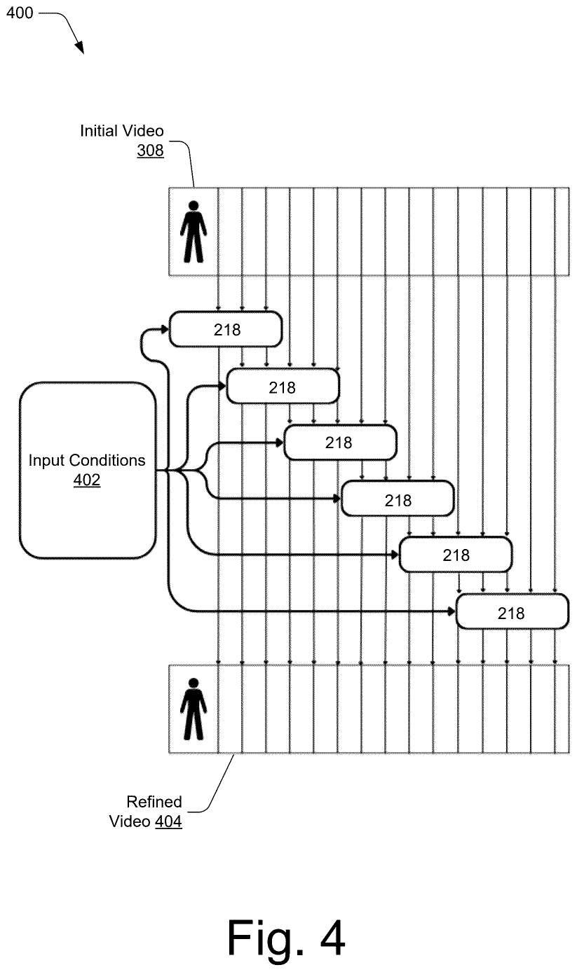

The output from the diffusion transformer 216 undergoes further refinement through a video refiner 218. The video refiner 218 enhances the quality and consistency of the generated video, addressing any artifacts or inconsistencies included in the initial output, and outputs the try-on video 122. The video refiner 218 may employ various techniques, including frame interpolation, super-resolution, and temporal consistency algorithms to refine the output from the diffusion transformer 216. In operation, the video refiner 218 analyzes consecutive frames, detects and corrects visual artifacts, and ensures smooth transitions between different poses or movements. The video refiner 218 can also adjust color balance, contrast, and sharpness to improve the overall visual appeal of the try-on video. In some implementations, the video refiner 218 utilizes machine-learning models trained on high-quality video datasets to guide the refinement process. The operation of the video refiner 218 is described in greater detail with respect to FIG. 4.

In accordance with the described techniques, the system 200 combines information from the subject image 116, garment image 118, the skeleton video 206, and/or text prompt 204 to create a realistic and dynamic representation of the subject wearing the selected clothing item. In other implementations, the inputs to the garment fit service include fewer or additional inputs than those illustrated in FIG. 2. The use of multiple VAEs 208 and conditioning networks 214 provides detailed encoding and processing of different aspects of the input data, while the diffusion transformer 216 and video refiner 218 ensure the generation of high-quality video output.

FIG. 3 illustrates a block diagram 300 of the conditioning networks 214 and diffusion transformer 216 of FIG. 2 for generating virtual try-on videos.

The diffusion transformer 216 includes multiple transformer layers 302. The transformer layers 302 process embedded inputs sequentially. Each transformer layer 302 may employ full three-dimensional (3D) attention mechanisms to capture relationships between different input elements across a video sequence, followed by feed-forward networks that further refine the representations. In some implementations, the transformer layers 302 incorporate multi-head self-attention mechanisms, allowing the model to focus on different aspects of the input data simultaneously. The transformer layers 302 may also utilize residual connections and layer normalization to facilitate gradient flow and stabilize training. As the input data progresses through the transformer layers 302, the model gradually refines and transforms the encoded information, generating increasingly detailed and coherent representations of the virtual try-on video 122.

The conditioning networks 214 include copied transformer layers 304 that mirror the structure of the transformer layers 302, allowing for consistent processing across different portions of the diffusion transformer 216. The copied transformer layers 304 in the conditioning networks 214 are specialized neural network components that process and refine the input sequences 210. In operation, the copied transformer layers 304 apply similar attention mechanisms and feed-forward networks to the conditioning signals, adapting them to be compatible with the transformer layers 302. By using copied transformer layers 304, the conditioning networks 214 prepare the conditioning signals for integration at each stage of the diffusion process within the diffusion transformer 216. This approach enables more seamless incorporation of the conditioning information throughout the video generation process to improve the quality and coherence of the try-on video 122.

Low-Rank Adaptation (LoRA) adaptors are incorporated into each copied transformer layer 304 of the conditioning networks 214 to enhance efficiency and performance. In one implementation, the LoRA adaptors are implemented as small, trainable matrices that are added to the weight matrices of the copied transformer layers 304, allowing for fine-tuning of specific parameters without modifying the network as a whole. In operation, the LoRA adaptors decompose the weight update into two low-rank matrices, reducing the number of trainable parameters while maintaining the model's capacity to learn task-specific adaptations. In this way, the conditioning networks 214 efficiently process and refine the input sequences 210 by focusing on relevant features for video generation. The use of LoRA adaptors in the copied transformer layers 304 also improve the system's ability to handle diverse garment styles, body shapes, and motion patterns while minimizing computational overhead.

Inputs to the diffusion transformer 216 includes the first sequence 210-1, which represents an encoded representation of the noisy video 202, and the second sequence 210-2, which represents an encoded representation of the text prompt 204. As described above, the noisy video 202 undergoes a flattening process using the first VAE 208-1, which converts the the video into a first sequence 210-1 in a latent space. The flattened first sequence 210-1 has a number of elements equal to the product of the number of frames (F), height (H), and width (W) of the noisy video 202. As described above, the text prompt 204 is processed through the text encoder 212 to generate the second sequence 210-2 in the latent space. The second sequence 210-2 is concatenated with the first sequence 210-1, which collectively are referred to as the “main sequence” at times in this document, at each transformer layer 302, allowing for text-guided modifications to the generated video.

The third sequence 210-3, fourth sequence 210-4, and fifth sequence 210-5 represent conditioning signals that are introduced at each transformer layer 302 via the conditioning networks 214. These inputs are first embedded into vector representations before being fed into the transformer layers 302. Concurrent to the video generation at the transformer layers 302 in the diffusion transformer 216, the conditioning networks 214 process auxiliary information from the subject image 116, garment image 118, and the reference video 120 to guide the video generation process. For example, the first conditioning network 214-1, the second conditioning network 214-2, and the third conditioning network 214-3 process the third sequence 210-3 (e.g., generated from the garment image 118), the fourth sequence 210-4 (e.g., generated from the subject image 116), and the fifth sequence 210-5 (e.g., generated from reference video 120 or the skeleton video 206), respectively. The garment and subject-image conditions are both pixel-unaligned and independent of the video frame index. To handle these conditions, the machine-learning system 114 treats these images as single-frame videos, converting them in a F-by-H-by-W sequence, with F (frames) equal to 1.

In one implementation, the input to each copied transformer layer 304 of the respective conditioning networks 214 is the corresponding input sequence 210 concatenated with the second sequence 210-2 (e.g., generated from the text prompt 204). For example, each copied transformer layer 304 of the first conditioning network 214-1 processes the concatenation of the second sequence 210-2 and the third sequence 210-3. Each copied transformer layer 304 of the second conditioning network 214-2 processes the concatenation of the second sequence 210-2 and the fourth sequence 210-4. Each copied transformer layer 304 of the third conditioning network 214-3 processes the concatenation of the second sequence 210-2 and the fifth sequence 210-5.

The outputs of the conditioning networks 214 are injected at various points within the transformer layers 302, guiding the generation process towards desired characteristics. Specifically, at each transformer layer 302, key values from sequences 210-3, 210-4, and 210-5 from the corresponding copied transformer layer 304 of the conditioning networks 214 are concatenated with the main sequence (e.g., the first sequence 210-1 concatenated with the second sequence 210-2) being processed by the diffusion transformer 216. For example, the input of the second transformer layer 302 includes the main sequence output from the first transformer layer 302 concatenated with key values of the sequences 210 output from the first copied transformer layer 304 of the conditioning networks 214.

As data flows through the diffusion transformer 216, the sequences gradually synthesize a coherent representation of the try-on video 122. The transformer layers 302 and copied transformer layers 304 function cooperatively to refine and transform the input sequences 210, with each layer building upon the output of the previous one. The first sequence outputs of the final transformer layer 302 is then processed through a variational autodecoder 306.

The variational autodecoder 306 is a neural network designed to convert latent representations back into the video or pixel space. In operation, the variational autodecoder 306 reconstructs the processed first sequence 210-1 from the final transformer layer 302 into a coherent video format, generating an initial video 308 of the try-on video. The variational autodecoder 306 can utilize techniques such as upsampling, deconvolution, or transposed convolution to gradually increase the spatial and temporal resolution of the latent representations. In one implementation, the variational autodecoder 306 also incorporates skip connections or residual blocks to preserve fine-grained details from earlier stages of the diffusion process. The variational autodecoder 306 may also employ adaptive instance normalization or other conditioning techniques to ensure that the generated video maintains the desired characteristics specified by the various input sequences 210. By leveraging probabilistic decoding methods, the variational autodecoder 306 introduces controlled variability into the initial video 308, potentially enhancing the realism and diversity.

The initial video 308 captures the important elements of the virtual try-on, including the subject's appearance, the garment's characteristics, and the reference movements. However, the initial video 308 may include artifacts or inconsistencies that require further refinement, which is described in greater detail with respect to FIG. 4.

FIG. 4 illustrates a block diagram of a system 400 for processing and refining video frames through multiple stages to generate a higher-quality refined video. The system 400 operates as part of the garment fit service 112 to enhance the visual quality and consistency of the try-on video 122 generated by the diffusion transformer 216.

The system 400 receives the initial video 308 as input, illustrated in FIG. 4 as a sequence of frames arranged horizontally at the top of the diagram. This initial video 308 corresponds to the initial try-on video output by the diffusion transformer 216, which may have a lower frame rate than desired for presentation to the user and may include visual artifacts or inconsistencies. In an example scenario, the initial video 308 includes 41 frames at 8 frames per second (FPS).

The system 400 processes the initial video 308 through multiple instances of the video refiner 218. The video refiners 218 convert the initial video 308 into a smoother, refined video 404 with additional frames and a faster frame rate, but also refines issues such as contrast, color distortion, blurriness, unnatural motions, and other defects or artifacts in the initial video 308. In the example scenario, the video refiners convert the initial video 308 into a 121-frame (e.g., approximately adding three times as many frames) video at 24 FPS (e.g., a three-fold increase in the frame rate). The video refiners 218 operate in an auto-regressive manner, refining the initial video 308 segment-by-segment with overlaps.

In one implementation, due to limited processor memory available or bandwidth, the video refiner 218 is trained to generate greater resolution videos by taking a segment of the input videos and upsampling them to include additional frames at a higher frame rate. For example, the video refiner 218 is trained to generate a 25-frame refined 24-FPS video from a 9-frame 8-FPS input video. The video refiner 218 is design by repeating each frame of the 8-FPS input video three times, converting the input video into a non-smooth 24-FPS video, and then a frame (F) by height (H) by width (W) sequence.

In the above scenario, a 121-frame video is generated by dividing it into seven segments with frame sizes of 25, 16, 16, 16, 16, 16, and 16. For the first segment (25 frames), the system 400 applies a standard generation process of the video refiner 218. For each subsequent segment (16 frames), the system 400 takes 9 frames from the refined video of the previous segment and uses them as the first 9 frames of the input video to the next instance of the video refiner 218. The system 400 uses input conditions 402, which represent the sequences 210 from FIGS. 2 and 3, to remove data augmentations during inference of the video refiner 218. The input conditions 402 are used to remove data augmentations, such as color jitter, Gaussian blur, VAE compression (e.g., encoding and decoding to and back from the latent space may result in loss details), noising, local pixel shuffling, and temporal blur. The input conditions 402 provide additional context and guidance for the refinement process, ensuring that the refined video maintains the appearance of the garment and the poses, reference movement, and look of the subject. The system 400 refines the first 9 frames of the try-on video 122 “as is” by applying a refining technique during inference. In this way, the system 400 uses the video refiner 218 to provide auto-regressive refinement of the initial video 308 to generate the refined video 404.

To train the video refiner 218, training data is constructed by downsampling raw 24-FPS videos to 8 FPS and applying data augmentations to the downsampled videos to simulate potential artifacts. This training strategy trains the video refiner 218 to remove artifacts from input videos and improve the visual quality.

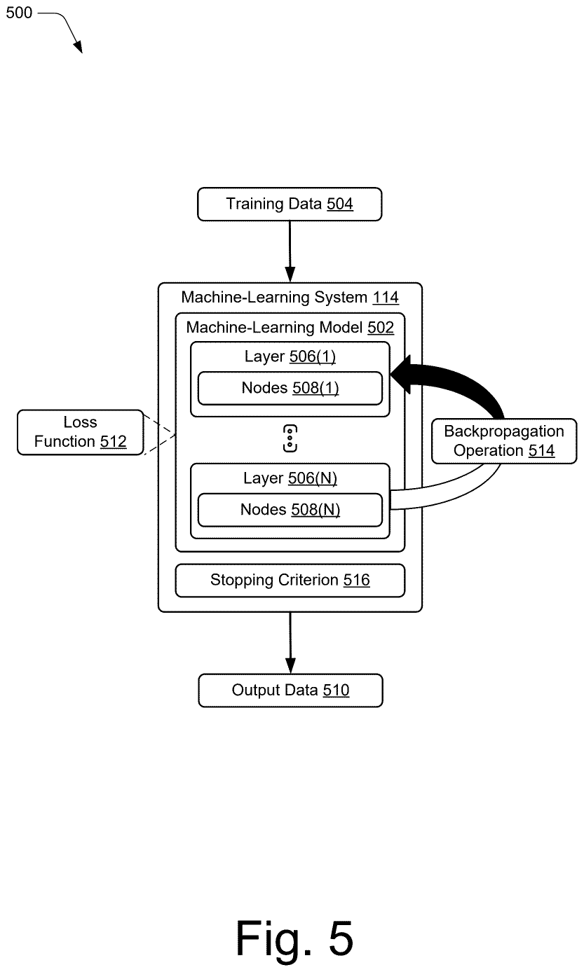

FIG. 5 depicts a system and procedure in an example implementation 500 for training a machine-learning model 502 as part of the machine-learning system 114 of FIG. 1. The machine-learning model 502 is illustrated as implemented as part of the machine-learning system 114. The machine-learning system 114 is representative of functionality to generate training data 504, use the generated training data 504 to train the machine-learning model 502, and/or use the trained machine-learning model 502 as implementing the functionality described herein.

A machine-learning model 502 refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), diffusion transformers, decision trees, support vector machines, linear regression, logistic regression, Bayesian networks, random forest learning, dimensionality reduction algorithms, boosting algorithms, deep learning neural networks, etc.

In this context, the machine-learning model 502 employs a diffusion transformer as described above. A “diffusion transformer” is a generative machine-learning model for digital content creation (e.g., try-on videos 122). To train the diffusion transformer, noise is added to training data samples until the data within the training data samples is obscured. The diffusion transformer is then trained self-supervised to reverse this process based on training data with a text prompt describing the digital content to be created to generate data samples as the digital content corresponding to the text prompt. To train the diffusion transformer, the underlying machine-learning model 502 is provided with training data 504 that includes examples of videos to train and retrain the model to predict the video to be generated.

In one implementation, the machine-learning model 502 also employs a parametric model. A parametric model uses a fixed number of parameters to represent the data (e.g., mesh models) it describes. In other words, these parameters act as the knobs turned to adjust the model's fit to the data. Parametric models use a finite or predetermined set of parameters. Because they have a fixed number of parameters, parametric models are often simpler to train and require less data than non-parametric models.

In the illustrated example, the machine-learning model 502 is configured using a plurality of layers 506(1), . . . , 506(N) having, respectively, a plurality of nodes 508(1), . . . , 508(N). The plurality of layers 506(1)-506(N) are configurable to include an input layer, an output layer, and one or more hidden layers. Calculations are performed by the nodes 508(1)-508(N) within the layers via hidden states through a system of weighted connections that are “learned” during training to implement a variety of tasks (e.g., caption generation).

To train the machine-learning model 502, training data 504 is received that provides examples of “what is to be learned” by the machine-learning model 502, i.e., as a basis to learn patterns from the data. As described above, the training data 504 includes training sample pairs. For each garment, example videos of people wearing the garment are collected with similar wearing styles. The videos are then decomposed into pairs and used as training data 504 for the style-transferring process. The training data 504, for example, includes a large-scale dataset with a large number of videos with high resolution to assist with training and validation purposes.

The machine-learning model 502, for instance, collects and preprocesses the training data 504 that includes input features and corresponding target labels, i.e., of what is exhibited by the input features. The machine-learning system 114 then initializes the parameters of the machine-learning model 502, which the machine-learning system 114 uses as internal variables to represent and process information during training and represent interferences gained through training. In an implementation, the training data 504 is separated into batches to improve the processing and optimization efficiency of the parameters during training.

The training data 504 is then received as input and used to generate predictions based on the current state of parameters of layers 506(1)-506(N) and corresponding nodes 508(1)-508(N) of the model. The machine-learning model 502 outputs its result as output data 510. Output data 510 describes an outcome of the task (e.g., generating a composite image).

Training the machine-learning model 502 includes calculating a loss function 512 to quantify a loss associated with operations performed by nodes 508 of the machine-learning model 502. For instance, calculating the loss function 512 includes comparing a difference between predictions specified in the output data 510 with target labels specified by the training data 504. The loss function 512 is configurable in various ways, including regression, the quadratic loss function as part of a least squares technique, and so forth.

Calculating the loss function 512 also includes using a backpropagation operation 514 to minimize the loss function 512, thereby training the parameters of the machine-learning model 502. Minimizing the loss function 512 includes adjusting the weights of the nodes 508(1)-508(N) to minimize the loss and thereby optimize the performance of the machine-learning model 502 for a particular task. The adjustment is determined by computing a gradient of the loss function 512, which indicates a direction to be used to adjust the parameters for minimizing the loss. The parameters of the machine-learning model 502 are then updated based on the computed gradient.

This process continues over several iterations until a stopping criterion 516 is met. The stopping criterion 516 is employed by the machine-learning system 114 in this example to reduce overfitting of the machine-learning model 502, reduce computational resource consumption, and promote an ability to address previously unseen data, i.e., that is not included specifically as an example in the training data 504. Examples of a stopping criterion 516 include but are not limited to a predefined number of epochs, validation loss stabilization, achievement of a performance improvement threshold, or based on performance metrics such as precision and recall.

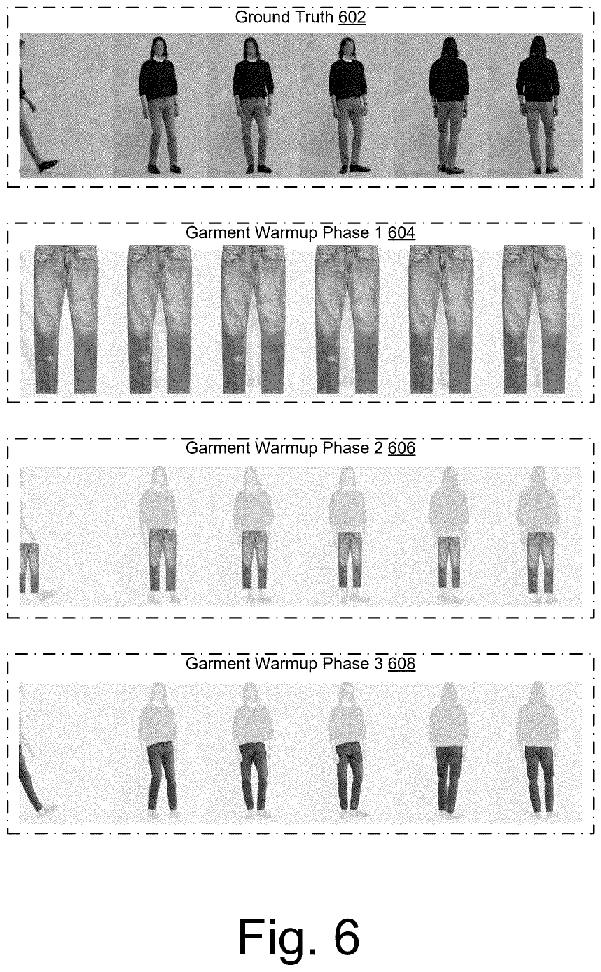

FIG. 6 illustrates a series of training phases for the garment try-on system. The training process consists of multiple phases designed to progressively enhance the ability of the diffusion transformer 216 to generate accurate and realistic virtual try-on videos by gradually increasing the correspondence between the video content and garment image.

In video-based virtual try-on tasks, machine-learning models struggle to fit garments onto persons across various poses. The virtual try-on tasks involves not only registering between garment images and the videos being generated, but also inferring and generating unseen views of the garments (e.g., back or side portions). Some pretrained models possess strong text-guided generation capabilities, which can hinder the optimization process for virtual try-on videos. During conventional training, the subject models tend to further enhance their already powerful text conditioning instead of learning the garment registration ability from scratch because it leads to a faster reduction in the loss. Consequently, such models struggle to develop an accurate try-on capability, even after extended training.

In contrast to these conventional training approaches for garment try-on, the described techniques uses a three-phase process involves garment image placement and defocusing, each phase being a simplified video generation task that gradually guides the diffusion transformer 216 to rely on the garment. In each phase, new target videos are constructed that emphasize specific contents by significantly reducing the contrast of other parts to defocus those parts.

The training process begins with a ground truth 602. The ground truth 602 includes video frames of a subject person wearing a particular garment from different perspectives or angles. In FIG. 6, the ground truth 602 shows a sequence of frames depicting a person wearing a black sweater and light-colored pants, viewed from different angles in a rotating position. The ground truth 602 establishes a baseline for the diffusion transformer 216 to learn human how garments fit and drape on a person.

Following the ground truth 602, the system progresses through the three garment warmup phases. In the first garment warmup phase 604, a large, flat garment image is placed at the center of each frame, with non-occluded areas defocused, allowing the model being trained to focus on copying the content from the garment image. In FIG. 6, a first garment warmup phase 604 displays a sequence of light-colored pants arranged in a flat layout configuration. The pants are shown consistently across multiple frames to establish the garment's appearance and details. This phase introduces the system to basic garment characteristics and teaches it to recognize and process clothing items.

The second garment warmup phase 606 positions the flat garment image in the same location as it appears in each frame similar to the ground truth 602, using a size similar to its occurrence. This warmup phase encourages the model to learn how to associate the garment with a human body. In FIG. 6, the second garment warmup phase 606 presents a video or video frames where the light-colored pants from the first garment warmup phase 604 are positioned relative to a faded or ghosted (or occluded) representation of the subject person. This phase maintains the garment's position while incorporating spatial relationships with the human form. The system learns to associate garments with body positions and understand how clothing interacts with different body parts.

In the third garment warmup phase 608, the garment is segmented in each frame of the ground truth 602, and other parts of the frame are defocused, guiding the model to learn garment registration. In FIG. 6, the third garment warmup phase 608 provides a video or video frames where the light-colored pants are integrated with a faded representation of the person from the ground truth 602, demonstrating how the garment appears in relation to body positioning and movement. This phase fine-tunes the system's ability to render garments realistically on moving human figures. In this manner, the diffusion transformer 216 can be trained using a relatively-fast convergence training (e.g., of a few hours per phase) to generate try-on videos 122 based on different garments.

In one implementation, the diffusion transformer 216 is further optimized through a four-stage training process with varying resolutions and conditioning sequences to improve convergence speed and reduce training costs. Instead of directly training with each condition at full resolution, the training process employs some conditions with reduced resolution. In the first stage, the system trains using the first conditioning sequence and the second conditioning sequence at a lower resolution (e.g., 768 by 480) for several iterations at increased speed (e.g., four times faster). The second stage increases the resolution (e.g., 1152 by 720) while still using only the first two conditioning sequences. In the third stage, the training system introduces the third conditioning sequence but returns to the lower resolution, and the fourth stage combines all three conditioning sequences at the increased resolution. During the lower-resolution training, the training system applies this resolution only to the videos, while still using the full resolution for the images. This multi-stage training process allows for faster iterative training without compromising the model's high-resolution generation capability.

Because image data can be easier to obtain than video data for training purposes, in one implementation the training system adopts a hybrid training approach with each batch include one video and two images. This hybrid training approach incurs minimal additional cost compared to video-only training, while allowing the diffusion transformer 216 to benefit from the diverse and abundant image data that is generally available.

Conventional training techniques for similar try-on models generally use paired data, where the ground truth videos or images depict the same garment as the input image. In such scenarios, the training procedure involves masking out the garment information from the ground truth and using it as input, creating a discrepancy between training and inference. In contrast, the described training system uses user images and/or videos wearing different (unpaired) garments in one implementation. Rather than applying masking, the training system leverages various pretrained image try-on models to perform image try-on on random frames of the video with random garments to generate unpaired user images. This unpaired training strategy trains the diffusion transformer 216 to have better alignment between the training and evaluation tasks.

These different training techniques collectively improves the garment try-on abilities of the diffusion transformer 216. In these ways, the diffusion transformer 216 progressively learns to handle increasingly complex scenarios, from basic garment recognition to realistic rendering of clothing on moving human figures. By the end of the training process, the diffusion transformer 216 is capable of generating high-quality, realistic virtual try-on videos that accurately represent how clothing items fit and move on different body types and in various poses.

### Example Animated Remote Apparel Fitting Procedures

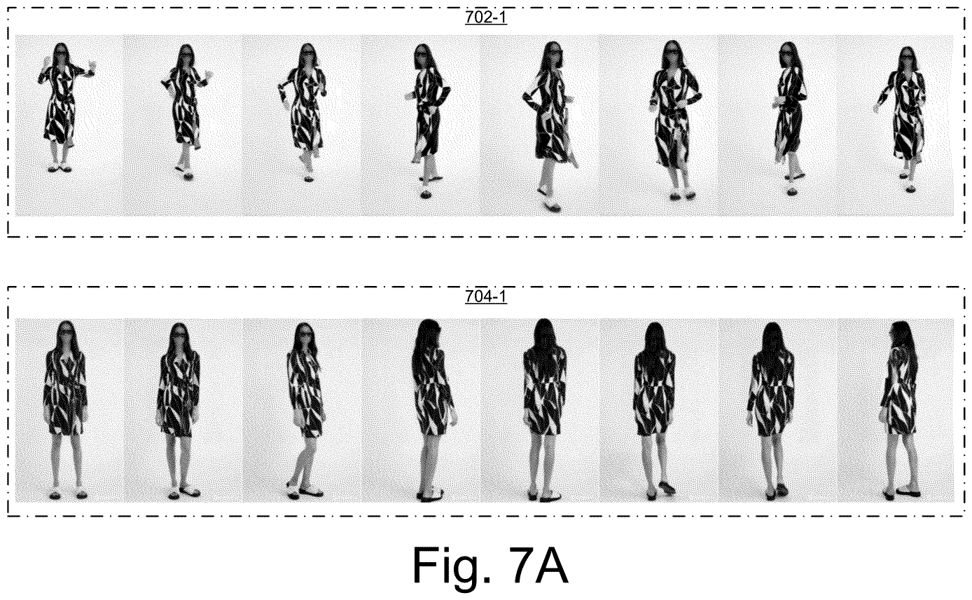

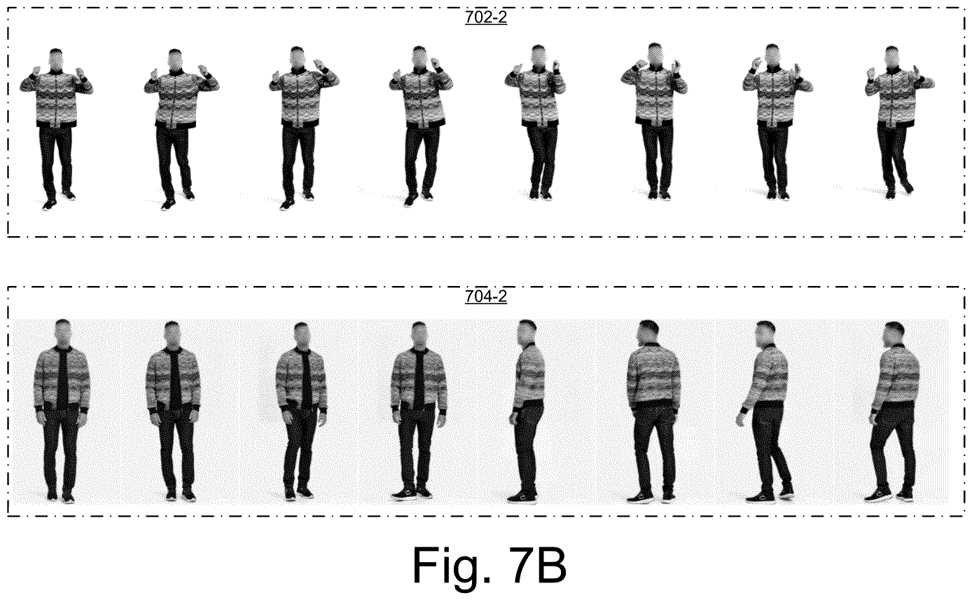

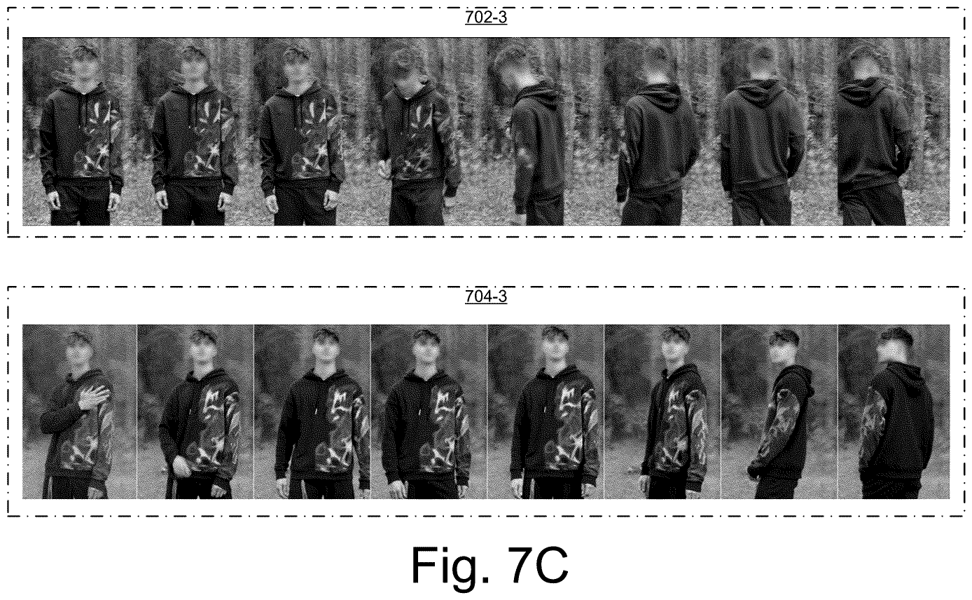

FIGS. 7A-7C illustrate virtual try-on demonstration sequences generated by the described garment fit service 112 and a conventional model. These sequences showcase the capability of the described techniques to produce realistic and dynamic representations of subjects wearing virtual clothing items in various poses and movements.

FIG. 7A depicts a try-on video 702-1 generated using the described techniques and another try-on video 704-1 generated using a conventional technique that uses a text prompt to describe the desired reference movements. By utilizing the reference video 120 or a skeleton video 206 derived from the reference video 120, the garment fit service 112 generates accurate dancing motion with accurate try-on results. In contrast, the conventional technique generates the try-on video 704-1 with simple turning motions. The ability of the described techniques to illustrate more complicated motions provides users with greater confidence in their online shopping experiences.

Similarly, FIG. 7B depicts a try-on video 702-2 generated using the described techniques and another try-on video 704-2 generated using a conventional technique that uses a text prompt to describe the desired reference movements. By utilizing the reference video 120 or a skeleton video 206 derived from the reference video 120, the garment fit service 112 generates accurate dancing motion with accurate try-on results. In contrast, the conventional technique generates the try-on video 704-2 with simple turning motions.

FIG. 7C depicts a try-on video 702-3 generated using the described techniques and another try-on video 704-3 generated using a conventional technique that uses a text prompt to describe the desired reference movements. By utilizing the reference video 120 or a skeleton video 206 derived from the reference video 120, the garment fit service 112 generates accurate dancing motion with high-quality virtual try-on results that faithfully preserve the garment patterns and user identity. In contrast, the conventional technique generates the try-on video 704-3 that fails to preserve the garment patterns at the top-right corner due to the occlusion in this area of the input subject image.

The following discussion describes animated remote apparel fitting techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm, e.g., responsive to execution of the instructions. In portions of the following discussion, reference will be made to FIGS. 1-7.

The following discussion describes animated remote apparel fitting techniques that are implementable utilizing the described systems and devices. Aspects of the procedure are implemented in hardware, firmware, software, or a combination thereof. The procedure is shown as a set of blocks that specify operations performable by hardware and are not necessarily limited to the orders shown for performing the operations by the respective blocks. Blocks of the procedure, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

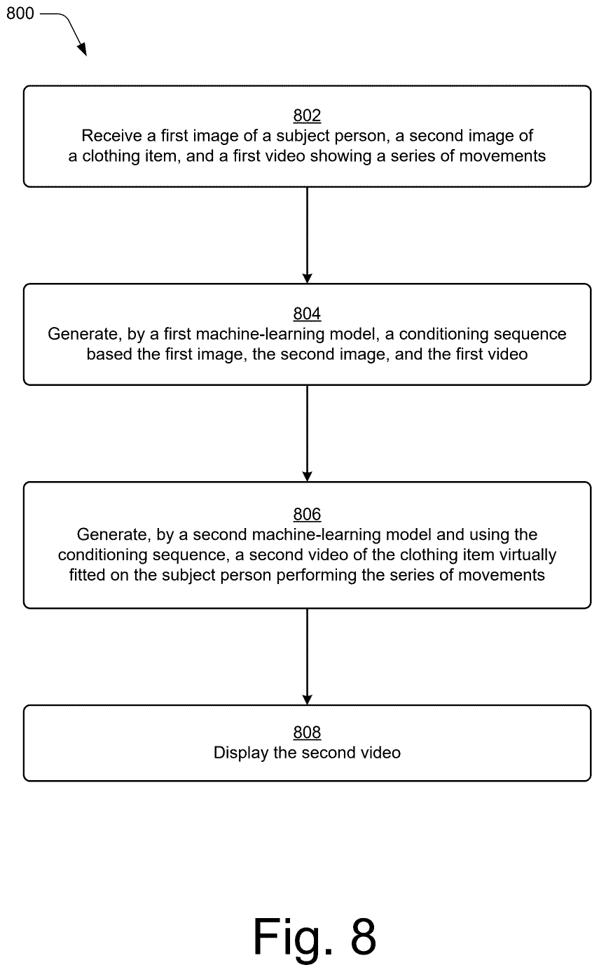

FIG. 8 illustrates a flowchart of a method 800 for an implementation of animated remote apparel fitting techniques as described herein.

At block 802, a first image of a subject person, a second image of a clothing item, and a first video showing a series of reference movements is received. By way of example, the first video is selectable from a predefined set of movement sequences. In at least one implementation, the garment fit service 112 provides an interface for a user to customize the series of movements via a text prompt in a natural language format.

Next, at block 804, a first machine-learning model generates a conditioning sequence based on the first image, the second image, and the first video. For example, the first machine-learning model includes one or more conditioning networks (e.g., the first conditioning network 214-1, the second conditioning network 214-2, and the third conditioning network 214-3). In one implementation, the garment fit service 112 or the conditioning networks 214 include variational autoencoders (VAEs) 204 to encode the input of the subject image 116, the garment image 118, and the reference video 120 into latent representations or sequences 210. For example, the third VAE 208 estimates human poses and extracts a skeleton video of the series of movements from the reference video 120. The skeleton video is converted into a sparse sequence of elements having a variable length that preserve sequence elements corresponding to non-background regions of the skeleton video.

At block 806, a second machine-learning model uses the conditioning sequence to generate a second video. The second video shows the clothing item virtually fitted on the subject person performing the series of reference movements. By way of example, the second machine-learning model includes a diffusion transformer 216 with multiple transformer layers and pre-trained parameters of a text-to-video diffusion model. The diffusion transformer 216 is trained using unpaired user images as training data, which are generated using image try-on models configured to generate an image try-on on random frames of a video with random garments.

In one or more implementations, garment fit service 112 also receives a text prompt providing edits to the reference movements in the reference video 120 or the clothing item in the garment image 118 to be included in the second video. The diffusion transformer 216 processes the text prompt to incorporate the specified edits into the generated second video.

At block 808, the second video is displayed. For example, the computer 104 presents the try-on video 122 via a display, allowing users to visualize how the clothing item fits and drapes on their body. Based on an analysis of the second video to detect potential fitting issues or style mismatches between the clothing item and the subject person, the garment fit service 112 can also generate suggestions for alternative clothing items or sizes. This additional analysis enhances the virtual try-on experience by providing users with recommendations and options to improve the shopping experience.

### Example System and Device

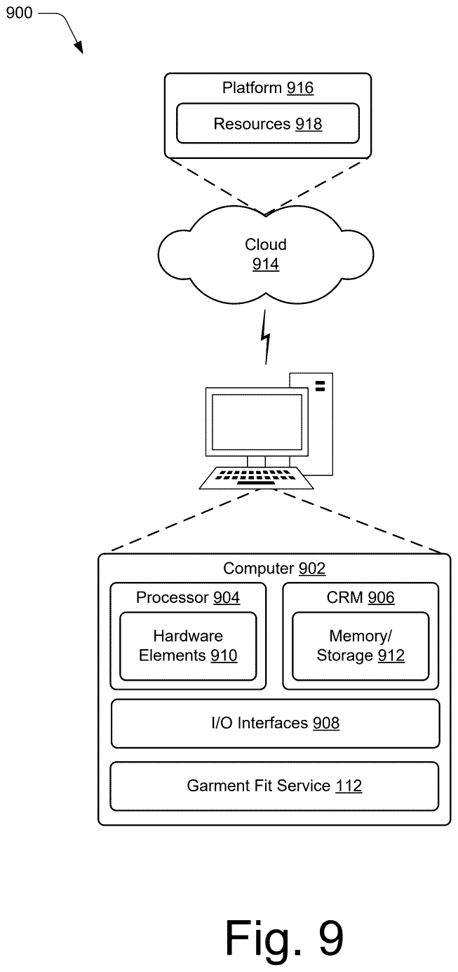

FIG. 9 illustrates an example system 900, which includes an example computer 902 that represents one or more computing systems and/or devices usable to implement the techniques described herein. This is illustrated through the inclusion of the garment fit service 112 of FIG. 1. The computer 902 is configurable, for example, as a service provider server, a device associated with a client (e.g., a client device, mobile device, laptop, desktop computer, tablet, notepad), an on-chip system, and/or any other suitable computing device or computing system.

The example computer 902, as illustrated, includes a processor 904, one or more computer-readable media 906 (“CRM”), and one or more I/O interfaces 908 that are communicatively coupled, one to another. Although not shown, the computer 902 includes a system bus or other data and command transfer system that couples the various components. For example, a system bus includes any combination of different bus structures, such as a memory bus or controller, a peripheral bus, a universal serial bus, and/or a processor or local bus that utilizes various bus architectures. Various other examples are also contemplated, such as control and data lines.

The processor 904 represents the functionality to perform one or more operations using hardware. Accordingly, processor 904 is illustrated as including hardware elements 910 that are configured as processors, functional blocks, and so forth. This includes example implementations in hardware, such as an application-specific integrated circuit or other logic device formed using one or more semiconductors. The hardware elements 910 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 906 is illustrated as including memory/storage 912. Memory/storage 912 represents memory or storage capacity associated with one or more computer-readable media. In one example, the memory/storage 912 includes volatile media (such as random access memory (RAM)) and/or nonvolatile media (such as read-only memory (ROM), Flash memory, optical disks, magnetic disks, and so forth). In another example, the memory/storage 912 includes fixed media (e.g., RAM, ROM, a fixed hard drive, and so on) and removable media (e.g., Flash memory, a removable hard drive, an optical disc, and so forth). The computer-readable media 906 is configurable in various ways, as described below.

Input/output interface(s) 908 are representative of functionality to allow a user to enter commands and information to computer 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computer 902 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

Implementations of the described modules and techniques are stored on or transmitted across some form of computer-readable media. For example, computer-readable media includes a variety of media that are accessible to computer 902. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computer 902, such as via a network. Signal media typically embodies computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic, and/or fixed device logic implemented in a hardware form that is employable in some examples to implement at least some aspects of the techniques described herein, such as to perform one or more instructions. Hardware includes components of an integrated circuit or on-chip system, an application-specific integrated circuit (ASIC), a graphics processing unit (GPU), an accelerator unit, an neural network engine, a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 910. For example, the computer 902 is configured to implement particular instructions and/or functions corresponding to the software and/or hardware modules. Accordingly, implementation of a module executable by the computer 902 as software is achieved at least partially in hardware, e.g., through computer-readable storage media and/or hardware elements 910 of the processor 904. The instructions and/or functions are executable/operable by one or more articles of manufacture (for example, one or more computers 902 and/or processors 904) to implement techniques, modules, and examples described herein.

The techniques described herein are supportable by various configurations of the computer 902 and are not limited to the specific examples of the techniques described herein. This functionality is also implementable entirely or partially through a distributed system, such as over a “cloud” 914, as described below.

Cloud 914 includes and/or represents a platform 916 for resources 918. The platform 916 abstracts the underlying functionality of hardware (e.g., servers) and software resources of the cloud 914. For example, resources 918 include applications and/or data utilized while computer processing is executed on servers remote from the computer 902. In some examples, the resources 918 also include services provided over the Internet and/or through a subscriber network, such as a cellular or Wi-Fi network.

Platform 916 abstracts the resources 918 and functions to connect the computer 902 with other computing devices. In some examples, the platform 916 also serves to abstract scaling of resources to provide a corresponding level of scale to encountered demand for the resources implemented via the platform. Accordingly, in an interconnected device example, the implementation of functionality described herein is distributable throughout system 900. For example, the functionality is partially implementable on computer 902 and via platform 916, which abstracts the functionality of cloud 914.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, a first image of a subject person, a second image of a clothing item, and a first video depicting a person moving with reference movements;
generating, by a first machine-learning model and based on the first image, the second image, and the first video, conditioning sequences;
generating, by a second machine-learning model and based on the conditioning sequences, a second video of the clothing item virtually fitted on the subject person moving with the reference movements; and
presenting, by the processing device via a display, the second video.

2. The method of claim 1 further comprising:
generating, using an auto-regressive video refiner to enhance a visual quality or a temporal consistency of the second video, a refined second video; and
presenting, by the processing device via the display, the refined second video.

3. The method of claim 1 wherein:
the first machine-learning model comprises one or more conditioning networks; and
the second machine-learning model comprises a diffusion transformer with multiple transformer layers and parameters of a pre-trained text-to-video diffusion model.

4. The method of claim 3 further comprising:
receiving a text prompt providing edits to the reference movements or the clothing item to be included in the second video.

5. The method of claim 4, wherein generating the second video comprises:
receiving an input of a noisy video with a first number (F) of frames and a resolution of a second number (H) by a third number (W);
generating, using a text encoder, a prompt sequence of the text prompt in a latent space having a fourth number (L) of elements;
encoding, using a first variational autoencoder (VAE), the noisy video into a video sequence of a fifth number of elements in the latent space, the fifth number of elements being equal to a product of the first number (F), the second number (H), and the third number (W);
concatenating, at each transformer layer of the diffusion transformer, the video sequence with the prompt sequence to generate a main sequence; and
applying, at each transformer layer, self-attention to the main sequence to generate the second video.

6. The method of claim 5, wherein generating the conditioning sequences comprises:
generating, using a second VAE on the first image, a first conditioning sequence of a sixth number of elements equal to the product of the resolution of the first image, the first image being treated as a single-frame video;
generating, using a third VAE on the second image, a second conditioning sequence of a seventh number of elements equal to the product of the resolution of the second image, the second image being treated as the single-frame video; and
generating, using a fourth VAE on the first video, a third conditioning sequence of an eighth number of elements.

7. The method of claim 6, wherein the fourth VAE is a pre-trained vision transformer configured to estimate human poses and extract a skeleton video of the reference movements from the first video, the skeleton video being converted into a sparse sequence of elements having a variable length that preserve sequence elements corresponding to non-background regions of the skeleton video.

8. The method of claim 6, wherein generating the second video further comprises:
passing the first conditioning sequence, the second conditioning sequence, and the third conditioning sequence through the one or more conditioning networks to obtain a first sequence, a second sequence, and a third sequence, respectively, at each layer of the one or more conditioning networks; and
concatenating, at each layer of the diffusion transformer, the first sequence, the second sequence, and the third sequence to the main sequence of a corresponding layer of the diffusion transformer.

9. The method of claim 3, wherein the diffusion transformer is trained using unpaired user images as training data, the unpaired user images being generated using image try-on models configured to generate an image try-on on random frames of a video with random garments.

10. The method of claim 3, wherein the diffusion transformer is optimized for generating portrayals of subject people wearing particular clothing items by:
in a first phase, placing a large, flat garment image at a center of each frame and defocusing each non-occluded area;
in a second phase, positioning the flat garment image in a same location as it appears in each frame of an input video; and
in a third phase, segmenting the garment in each frame and defocusing other parts of the frame.

11. The method of claim 10, wherein the diffusion transformer is further optimized by:
in a first stage, training the diffusion transformer using the first conditioning sequence and the second conditioning sequence at a lower resolution for several iterations at increased speed;
in a second stage, training the diffusion transformer using the first conditioning sequence and the second conditioning sequence at an increased resolution for several iterations;
in a third stage, training the diffusion transformer using the first conditioning sequence, the second conditioning sequence, and the third conditioning sequence at the lower resolution for several iterations at the increased speed; and
in a fourth stage, training the diffusion transformer using the first conditioning sequence, the second conditioning sequence, and the third conditioning sequence at the increased resolution for several iterations.

12. The method of claim 1 further comprising:
receiving, via a text prompt, user input to modify one or more attributes of the clothing item; and
generating, based on the text prompt and using the second machine-learning model, a third video of the modified clothing item virtually fitted on the subject person moving with the reference movements.

13. The method of claim 1, wherein the first video depicting the reference movements is selected from a predefined set of movement sequences, and wherein the method further comprises:
providing an interface for a user to select or customize the reference movements to be performed in the second video via a text prompt in a natural language format.

14. The method of claim 1 further comprising:
analyzing the second video to detect potential fitting issues or style mismatches between the clothing item and the subject person; and
generating suggestions for alternative clothing items or sizes based on the second video.

15. A computing device comprising:
a memory; and
a processor coupled to the memory and configured to:
receive a first image of a subject person, a second image of a clothing item, and a first video depicting a person moving with reference movements;
generate, by one or more conditioning networks and based on the first image, the second image, and the first video, conditioning sequences;
generate, by a diffusion transformer with multiple transformer layers and parameters of a pre-trained text-to-video diffusion model, a second video of the clothing item virtually fitted on the subject person moving with the reference movements based on the conditioning sequences; and
present, via a display, the second video.

16. The computing device of claim 15, wherein:
the processor is further configured to receive a text prompt providing edits to the reference movements or the clothing item to be included in the second video; and
generating the second video causes the processor to:
receive an input of a noisy video with a first number (F) of frames and a resolution of a second number (H) by a third number (W);
generate, using a text encoder, a prompt sequence of the text prompt in a latent space having a fourth number (L) of elements;
encode, using a first variational autoencoder (VAE), the noisy video into a video sequence of a fifth number of elements in the latent space, the fifth number of elements being equal to a product of the first number (F), the second number (H), and the third number (W);
concatenate, at each transformer layer of the diffusion transformer, the video sequence with the prompt sequence to generate a main sequence; and
apply, at each transformer layer, self-attention to the main sequence to generate the second video.

17. The computing device of claim 16, wherein generating the conditioning sequences causes the processor to:
generate, using a second VAE on the first image, a first conditioning sequence of a sixth number of elements equal to the product of the resolution of the first image, the first image being treated as a single-frame video;
generate, using a third VAE on the second image, a second conditioning sequence of a seventh number of elements equal to the product of the resolution of the second image, the second image being treated as the single-frame video; and
generate, using a fourth VAE on the first video, a third conditioning sequence of an eighth number of elements.

18. The computing device of claim 17, wherein generating the second video further causes the processor to:
pass the first conditioning sequence, the second conditioning sequence, and the third conditioning sequence through the one or more conditioning networks to obtain a first sequence, a second sequence, and a third sequence, respectively, at each layer of the one or more conditioning networks; and
concatenate, at each layer of the diffusion transformer, the first sequence, the second sequence, and the third sequence to the main sequence of a corresponding layer of the diffusion transformer.

19. The computing device of claim 15, wherein the diffusion transformer is optimized to generate portrayals of subject people wearing particular clothing items by:
in a first phase, placing a large, flat garment image at a center of each frame and defocusing each non-occluded area;
in a second phase, positioning the flat garment image in a same location as it appears in each frame of an input video; and
in a third phase, segmenting the garment in each frame and defocusing other parts of the frame.

20. One or more computer-readable storage media storing instructions that, responsive to execution by a processing device, causes the processing device to:
receive a first image of a subject person, a second image of a clothing item, and a first video depicting a person moving with reference movements;
generate, by one or more conditioning networks and based on the first image, the second image, and the first video, conditioning sequences;
generate, by a diffusion transformer with multiple transformer layers and parameters of a pre-trained text-to-video diffusion model, a second video of the clothing item virtually fitted on the subject person moving with the reference movements based on the conditioning sequences; and
present, via a display, the second video.
